(19) United States
(12) Patent Application Publication
(10) Pub. No.: US 2008/0169625 A1
(43) Pub. Date: Jul. 17, 2008

(54) Roller-wheeled bike structure

(75) Inventor: Ken Yen Tang, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: WHEEL TA ENT CO., LTD.

(21) Appl. No.: 11/652,662

(22) Filed: Jan. 12, 2007

(51) Int. Cl. B62K 5/00

(52) U.S. Cl. 280/282

(57) ABSTRACT

A roller-wheeled bike structure comprises a main frame with a seat tube locked to a seatpost topped by a saddle with a level handle extending at the front lower section. A lower bracket having a five-way tube connected to a pedal chain set is welded to the lower front side of the seat tube. A rear fork is joined both to the back side of the lower bracket and the middle section of the seat tube. A transverse-extending guide shaft of the front wheel seat has both ends equipped with a guide plate and a front wheel respectively and conjoined to each other by a parallel link. The connecting tube is fixed to the lower bracket for the mounting of an operational control post composed of a coupling tube and a support rod. Therefore, the roller-wheeled bike can be stably ridden in multiple ways and economically collapsed for packing/shipping purposes.

### BACKGROUND OF THE INVENTION

The present invention relates to a roller-wheeled bike structure, comprising a main frame, a front wheel seat, a connecting tube, and an operational control post wherein the roller-wheeled bike can be flexibly assembled with or without the operational control post mounted thereto according to the preference of a rider to provide versatile and fun riding experience thereby, and the operational control post can easily control the turning operation of the bike in a stable and smooth manner; moreover, the roller-wheeled bike can be conveniently collapsed into smaller volume for economical packing/shipping thereof.

Please refer to FIG. 1. A conventional skate bike 10 is made up of an integrally molded and transversely V-shaped seat tube 11 equipped with a quick-release seat clamp 12 at the upper section to lock a seatpost 13 topped by a saddle 14 thereto. The saddle 14 has a level handle 141 extending at the front lower section thereon, and seat tube 11 has a middle section with a rear fork 15 secured to the rear side thereto. The rear fork 15 has locking plates welded at the rear bottom section, and a rear wheel 16 is pivotally joined to the end sections of the locking plates thereon. Then, the seat tube 11 has the upper section precisely located above the front top section of the rear wheel 16, and the lower section bent to extend forwards with a five-way tube attached to the middle of the front side thereon for the engagement of a pedal chain set 18 therewith. In addition, front wheels 19 are pivotally locked to the front end of the seat tube 11 thereon.

In riding application of the skate bike, a rider can have hands resting onto the level handle 141 disposed at the front side of the saddle 14 while swinging the body to tilt the gravitation thereof towards one side so as to control the front wheels 19 making a left or right turn thereby.

There are some drawbacks to such conventional skate bike structure. First, to make a turn, a rider must swing the body to control the turning direction, which is both painstaking and inconvenient to do. Besides, it is rather inflexible and difficult to control the turning operation of the skate bike thereof. Second, while the rider makes a turn, the front wheels 19 are switched to rotate in a small angle, which relatively increases the turning radius required. Thus, the skate bike 10 is more difficultly and awkwardly ridden, which can easily cause the rider to fall downwards there-from. Third, the rider simply swings the body to turn the skate bike 10, which makes its operation rather dully and monotonously similar to the ordinary bikes. Fourth, the seat tube 11 has the upper section precisely located above the front side of the rear wheel 16, which makes up a rather tall height of the skate bike 10 as a whole. Even if the seatpost 13 is collected downwards to the lowest position or dismantled there-from to put aside as shown in FIG. 1, the skate bike 10 still features a rather tall height, which means more materials are required to pack up the large volume of the collected skate bike 10, and, thus, increase the cost of package thereby. Fifth, due to its relatively large volume, the collapsed skate bike 10 may occupy a lot of space in shipping and uneconomically increase the cost of shipment thereby.

### SUMMARY OF THE PRESENT INVENTION

It is, therefore, the primary purpose of the present invention to provide a roller-wheeled bike structure, comprising a main frame, a front wheel seat, a connecting tube, and an operational control post wherein, to make a turn of the roller-wheeled bike, a rider simply has the hand swing left-and-right the operational control post to control the turning direction of the main frame without the body moving for the purpose, achieving an easy and efforts-saving riding as well as smooth and versatile control of the roller-wheeled bike in turning operation.

It is, therefore, the second purpose of the present invention to provide a roller-wheeled bike structure wherein the rider swings the body or the operational control post to make a turn of the roller-wheeled bike; whereby, when one front wheel is turned to rotate towards a direction, the other front wheel will be moved to the same direction and angle via the actuation of a parallel link. Thus, both front wheels are synchronically switched in identical angle to rotate in relatively smaller turning radius so that the rider can ride on the roller-wheeled bike in a smooth and flexible manner.

It is, therefore, the third purpose of the present invention to provide a roller-wheeled bike structure wherein the roller-wheeled bike can be assembled with or without the operational control post mounted thereto according to a rider's preference and the riding condition. Without the operational control post, a rider can swing the body to switch the direction of the roller-wheeled bike, while, with the operational control post, the rider simply has one hand holding and swinging a grip portion of the operational control post to control the turning direction thereof, providing versatile and fun riding experience thereby.

It is, therefore, the fourth purpose of the present invention to provide a roller-wheeled bike structure wherein the roller-wheeled bike can be easily collapsed into a smaller height, economically saving the material and cost of packing thereof.

It is, therefore, the fifth purpose of the present invention to provide a roller-wheeled bike structure wherein the roller-wheeled bike can be packed into a smaller volume as a whole with smaller space occupied thereby, facilitating the shipment thereof.

### BRIEF DESCRIPTION OF THE DRAWINGS

FIG. 1 is a perspective view of a conventional skate bike and the operation of its collection thereof.

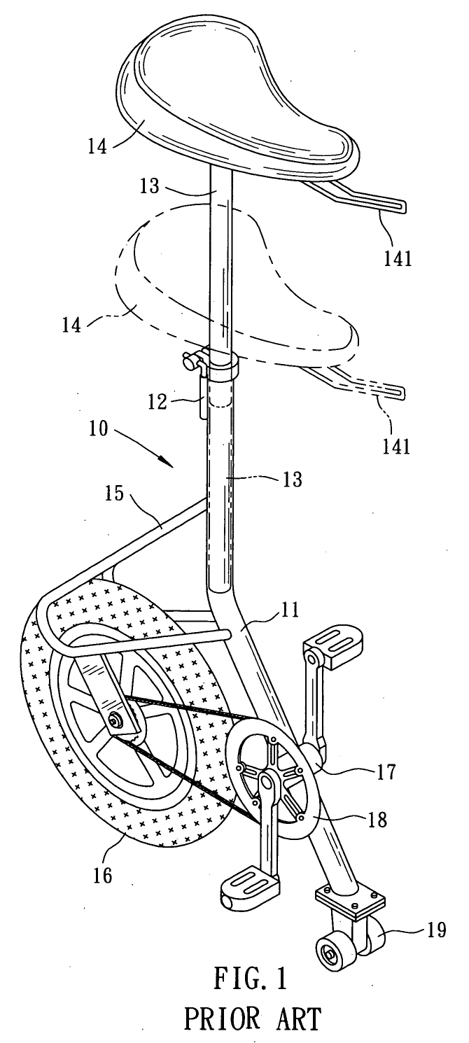

FIG. 2 is an exploded perspective view of the present invention.

FIG. 3 is an assembled perspective view of the present invention.

FIG. 4 is another assembled perspective view of the present invention.

FIG. 5 is a third assembled perspective view of the present invention.

### DETAILED DESCRIPTION OF THE PREFERRED EMBODIMENTS

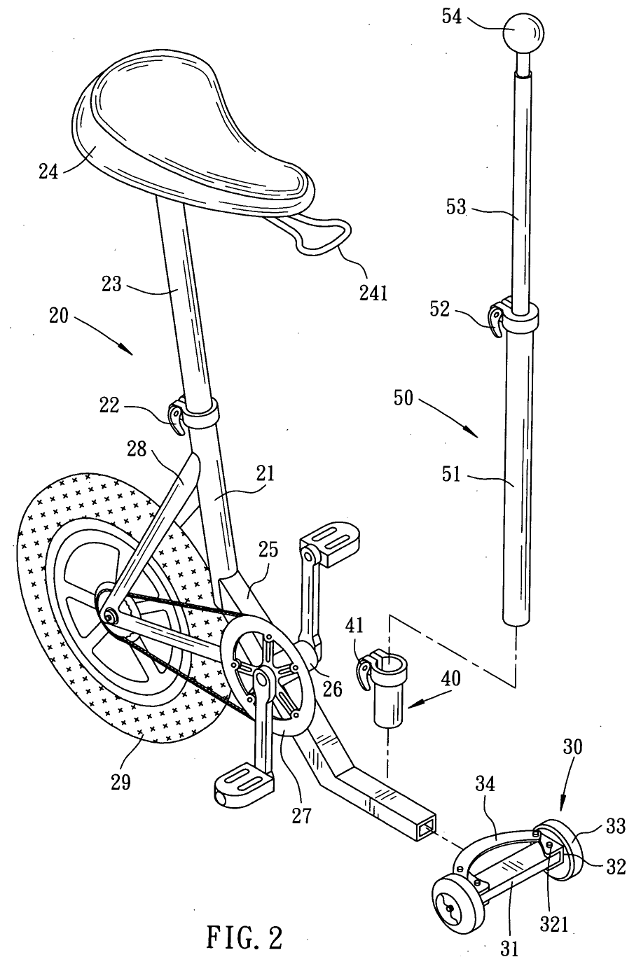

Please refer to FIG. 2 showing an exploded perspective view of the present invention. The present invention relates to a roller-wheeled bike structure, comprising a main frame 20, a front wheel seat 30, a connecting tube 40, and an operational control post 50. The main frame 20 includes a seat tube 21 having a quick-release seat clamp 22 fixed at the upper section to lock to the seat tube 21 a seat post 23 having a saddle 24 attached at the top thereon. The saddle 24 has a level handle 241 extending at the front lower section thereon, and the seat tube 21 has a lower bracket 25 fixedly welded thereto to extend forwards at the lower front section thereon. The lower bracket 25 is made up of an oblique-extending rear section and a level-extending front section, and equipped with a five-way tube 26 secured in the middle of the rear section thereon for the engagement of a pedal chain set 27 therewith. The lower bracket 25 has a rear fork 28 fixed to the back side of the rear section thereon. The rear fork 28 is also connected to the middle section of the seat tube 21, and a rear wheel 29 is pivotally joined to the rear end point of the rear fork 28. Then, the rear wheel 29 and the pedal chain set 27 are spaced out in an appropriate distance from each other with the seat tube 21 precisely positioned there-between. The front wheel seat 30 is equipped with a transversely-extending and front-low-and-rear-high sloped guide shaft 31 that has a transverse U-shaped guide plate 32 fixed at both left and right end sides thereon via a pivoting axle 321 respectively. Each guide plate 32 has a front wheel 33 pivotally attached to the center of the outer side thereon. And a parallel link 34 has both ends attached to the rear upper sides of the guide plates 32 to connect both thereby. The connecting tube 40 is shaped in a hollow and short cylindrical body into which the operational control post 50 can be inserted for location thereby, and a quick-release clamp 41 is bound to the upper section of the connecting tube 40 thereon. The operational control post 50 is made up of a coupling tube 51, a support rod 53 locked to the coupling tube 51 via a quick-release element 52 disposed at the top end thereon, and a ball-shaped grip portion 54 attached to the top of the support rod 53 thereon.

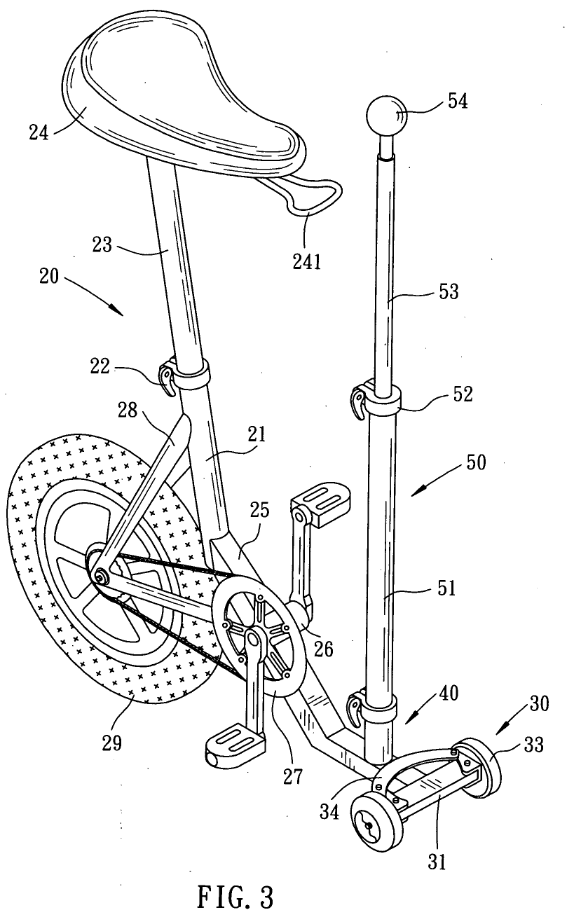

In assembly (referring to FIG. 3), via welding operation, the guide shaft 31 of the front wheel seat 30 has the rear central section welding-fixed to the front end side of the lower bracket 25 of the main frame 20, and the connecting tube 40 has the bottom end welding-bound to the upper surface of the front section of the lower bracket 25. Then, the operational control post 50 has the coupling tube 51 inserted into the connecting tube 40 therein and fixedly locked thereto via the quick-release clamp 41 thereby to complete the assembly of a roller-wheeled bike that is easy to control and provides multiple ways of riding thereon.

In riding application, the roller-wheeled bike of the present invention can be assembled with or without the connecting tube 40 mounted thereto according to the preference of a rider, providing versatile and fin riding experience thereby. When the operational control post 50 is mounted to the connecting tube 40, the rider can have one hand holding onto the level handle 241 disposed at the front side of the saddle 24 and the other hand grasping the grip portion 54 of the operational control post 50. Then, to make a turn of the roller-wheeled bike, the rider can directly swing left and right the operational control post 50 by the hand so as to tilt the gravitation thereof towards one side without moving the body. The connecting tube 40 with the operational control post 50 mounted thereto is integrally welded to the main frame 20 with the guide shaft 31 of the front wheel seat 30 linked thereto at the front end of the lower bracket 25. Therefore, when the total gravitation thereof switches obliquely towards the right, the guide shaft 31 will simultaneously slant towards the right therewith, making the two guide plates 32 pivotally turn via the pivoting axles 321 towards the right as well. Meanwhile, the parallel link 34 will be synchronically actuated to push the symmetrical front wheels 33 rolling towards the right in identical angle therewith to ensure a relatively smaller rotating radius in the turning operation thereof. Thus, the roller-wheeled bike of the present invention can be smoothly and flexibly operated as to fit to the practice of a beginner. In other cases, when the operational control post 50 is removed from the connecting tube 40, a rider can have a hand resting on the level handle 241 disposed at the front of the saddle 24 while swinging the body to-and-fro to control the front wheels 33 of the front wheel seat 30 making a right or left turn thereby. Thus, the roller-wheeled bike of the present invention can also suit an initiated rider for free riding experience thereof.

To collect the roller-wheeled bike thereof, the quick-release element 52 mounted to the coupling tube 51 of the operational control post 50 is loosened so that the support rod 53 can be flexibly adjusted downwards to the bottommost position. And, the quick-release clamp 41 of the connecting tube 40 is also loosened so that the operational control post 50 can be dismantled there-from and transversely positioned alongside the main frame 20. Then, the quick-release seat clamp 22 of the seat-tube 21 thereof is unlocked so that the seatpost 23 can also be adjusted downwards. Because the seat tube 21 is precisely positioned between the rear wheel 29 and the pedal chain set 27 and both of the rear wheel 29 and the pedal chain set 27 are appropriately spaced from each other, the seatpost 23 can descend directly downwards to accommodate into the seat tube 21, and have the bottommost end thereof stored up between the rear wheel 29 and the pedal chain set 27 and collapsed into the lowest position. Therefore, the total height of the collected roller-wheeled bike can be greatly reduced thereby. Otherwise, the above seatpost 23 can also be dismantled there-from and located alongside the main frame 20 so as to reduce even more the total height of the roller-wheeled bike for packing and shipping purposes with smaller space occupied thereby.

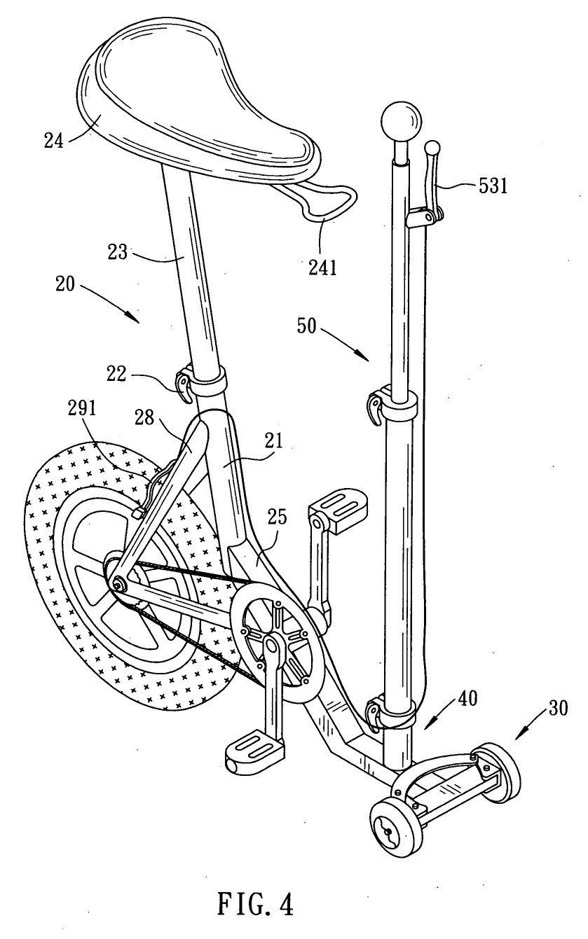

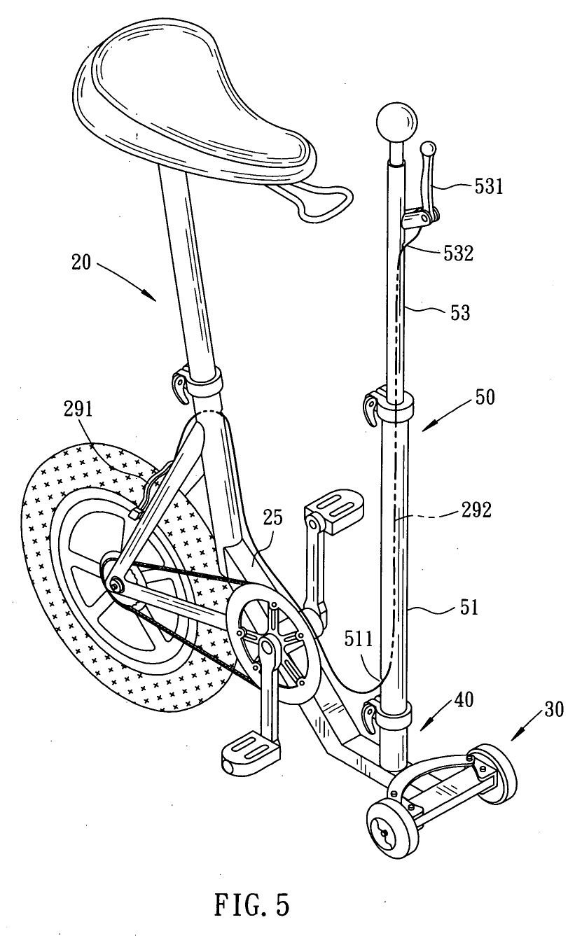

Please refer to FIG. 4. The operational control post 50 can also have a brake handle 531 mounted to one side at the upper section of the support rod 53 thereon to correspond to a rear braking device 291 attached to the rear wheel 29 thereon. Thus, in addition to being pedaled backwards for a stop by means of another rear braking device mounted on the hub of the rear wheel 29, the roller-wheeled bike of the present invention can also provide a brake handle 531 for the beginners who are used to hand brake in case of braking operation, achieving double braking functions thereby. Moreover, the operational control post 50 (referring to FIG. 5) can also have a thru-hole 511, 532 respectively drilled onto the preset position of the coupling tube 51 and the support rod 53 so that a braking cord 292 having both ends respectively linked to the rear braking device 291 and the braking handle 531 thereof can thread through the thru-holes 511, 532 respectively to extend and conceal inside the operational control post 50 thereby.

What is claimed is:

1. A roller-wheeled bike structure, comprising a main frame, a front wheel seat, a connecting tube, and an operational control post wherein the main frame includes a seat tube having a quick-release seat clamp fixed at the upper section thereon to lock a seatpost having a saddle attached at the top end thereon; the saddle has a level handle extending at the front lower section thereon, and the seat tube has a lower bracket welded thereto to extend forwards at the lower front section thereon wherein the lower bracket is made up of an oblique-extending rear section and a level-extending front section and equipped with a five-way tube secured to the front side in the middle of the rear section thereon to which a pedal chain set is mounted thereon; the lower bracket also has a rear fork fixed to the back side of the rear section thereon, and the rear fork is also connected to the middle section of the seat tube; a rear wheel is pivotally joined to the rear end point of the rear fork, permitting the rear wheel and the pedal chain set to appropriately space out from each other with the seat tube precisely positioned there-between; the present invention being characterized by that,
the front wheel seat, welded to the front end side of the lower bracket of the main frame, being equipped with a transversely-extending guide shaft, and a set of corresponding transverse U-shaped guide plates symmetrically mounted to both left and right end sides of the guide shaft via a pivoting axle respectively wherein each guide plate has a front wheel pivotally attached to the center of the outer side thereon, and a parallel link has both ends attached to the upper rear sides of the guide plates to connect both thereby;
the connecting tube having a quick-release clamp bound to the upper section thereon to fix the operational control post thereto;
the operational control post being made up of a coupling tube having a quick-release element bound to the upper section to lock a support rod thereto, and a grip portion attached to the top end of the support rod thereon;
therefore, via the aforementioned structure, the roller-wheeled bike of the present invention can be flexibly assembled with or without the operational control post mounted thereto according to the preference of a rider to provide versatile and fun riding experience thereby; besides, the operational control post is utilized to easily control the turning operation of the bike in a convenient and smooth manner, and both front wheels are allowed to identically turn towards the same direction in same angle so that a rider can maintain stable gravitation without the danger of falling downwards from the bike thereof.

2. The roller-wheeled bike structure as claimed in claim 1 wherein the guide shaft is obliquely sloped into a front-low-and-rear-high form.

3. The roller-wheeled bike structure as claimed in claim 1 wherein the connecting tube is shaped into a hollow and short cylindrical body.

4. The roller-wheeled bike structure as claimed in claim 1 wherein the grip portion of the operational tube is formed into a ball-shaped configuration.

5. The roller-wheeled bike structure as claimed in claim 1 wherein the operational control post can also have a braking handle mounted to one side at the upper section of the support rod thereon to correspond to a rear braking device attached to the rear wheel thereon so that the roller-wheeled bike can be stopped by both backward-pedaling operation and the braking handle with double braking functions thereby.

6. The roller-wheeled bike structure as claimed in claim 1 wherein the operational control post can also have a thru-hole respectively drilled onto the preset position of the coupling tube and the support rod so that a braking cord having both ends respectively linked to the rear braking device and the braking handle can thread through the thru-holes respectively to extend and conceal inside the operational control post thereby.

7. The roller-wheeled bike structure as claimed in claim 1 wherein the lower bracket of the main frame can also have the front section bent to curve downwards into an arcuate shape.
